(19) United States
(12) Patent Application Publication
(10) Pub. No.: US 2025/0216894 A1
(43) Pub. Date: Jul. 3, 2025

(54) LAPTOP CASE WITH FOLDABLE SHADE

(71) Applicant: Anywhere LLC, Denver, CO (US)

(72) Inventor: Ryan John Chase, Santa Monica, CA (US)

(21) Appl. No.: 18/402,617

(22) Filed: Jan. 2, 2024

(51) Int. Cl. G06F 1/16

(52) U.S. Cl. CPC G06F 1/1628; G06F 1/1603

(57) ABSTRACT

A laptop case and foldable shade system consisting of a clamshell style laptop case with a lid half and a base half connected via a hinge, and a shade assembly with a top visor panel and side panels on each side of the case. The top visor panel attaches to an upper edge of the case lid via a hinge and extends outward to shield a laptop placed within the opened case from direct sunlight. The side panels consist of an upper and a lower side panel wherein the upper side panel is connected to the top visor panel and the lower side panel is connected to the case lid. When stowing the shade assembly, the top visor panel folds downward from its extended position as the side panels fold inward to a flattened position along the interior surface of the case lid.

### BACKGROUND OF THE INVENTION

The present invention relates to laptop accessories and, more particularly, a laptop case containing a shade assembly, wherein the shade assembly can be folded flat and stored along the interior planar surface of the case.

A laptop (also known as a laptop computer or notebook computer) is a small, portable personal computer having a monitor on its upper half and a keyboard its bottom half, which are connected via a hinge. The monitor and keyboard can be positioned at a desired angle between a closed configuration and an open configuration via a hinge mechanism, which also allows for adjustable viewing angles to optimize use. The compact, portable nature of laptops allows for their use almost anywhere, but when being used outdoors or near a window, sunlight can cause an obstructive glare on the monitor and/or cause the laptop to overheat.

Laptop cases can keep sunlight off the body of the laptop; however, current laptop cases do not have a shade-like assembly attached to the lid of the case that partially blocks the monitor and keyboard components from direct sunlight exposure when the laptop is in the open configuration. This forces the user to improvise using makeshift shades which tend to lack a secure attachment to the case, and which are not specifically designed to be folded flat and be stored in the interior of the laptop case when not in use.

As can be seen, there is a need for a laptop case with a foldable shade assembly which can be attached to a portion of the perimeter of the case lid to shade a laptop from unwanted light or sunlight, thereby reducing glare and preventing the laptop from overheating when placed in direct sunlight, and wherein the shade assembly can be folded flat for convenient storage along the interior surface of the same laptop case.

Furthermore, there is a need for additional functionality for working remotely that can be included with the laptop case and foldable shade assembly, including the ability to connect the case to a tripod or four-legged stand, and a built-in battery for extended laptop usage in remote locations when outlets are not available to provide a power source.

There is also a need for a laptop case and foldable shade assembly wherein the shade assembly is removably attached and can be detached and replaced with another shade assembly for interoperability.

### SUMMARY OF THE INVENTION

The primary invention is a clamshell style laptop case and foldable shade and mounting plate. The clamshell style case consists of two halves: a lid and a base, joined together along their adjacent rear edge. The shade assembly consists of a top visor panel along with two side panels on each side of the case. The top visor panel can be attached to the upper edge of the case lid and is movable between an extended position and a folded position. In the extended position, the top visor panel of the shade assembly is attached to a perimeter of the case lid and extended outward in order to maximize the coverage over a laptop contained within the open case, creating an awning or hood over the top of the laptop. In the folded position, the shade assembly can be securely stored along an interior surface of the lid portion of the case.

The present invention contains two side panels on each of the left and right sides of the case lid: an upper side panel and a lower side panel, wherein the upper side panel is attached to the top visor panel on either the left or right side, and the lower side panel is attached to the case lid on either the left or a right side.

The shade assembly of the present invention can be moved from its expanded position to its folded position by lowering the top visor panel while the upper side panels and lower side panels fold inward along the interior planar surface of the case lid. When fully folded, the top visor panel and side panels are flattened and positioned within the interior planar surface of the case lid. The upper side panel and the lower side panel on each side of the case are connected by a joining hinge, which may be a living hinge, friction hinge, piano hinge, or spring hinge. When moving the shade to its folded position, the upper and lower side panels fold inward along their joining hinge. In this embodiment, when stowing the shade assembly, the top visor panel folds downward from its extended position as the upper and lower side panels fold inward along the interior planar surface of the case lid in a flattened position, substantially parallel with the interior surface of the lid.

The present invention contemplates a recess along the bottom of the base of the case whereby the base of the case can connect to a mounting plate with connection mechanisms to mount to a tripod or four-legged stand in order to create a portable or mobile desk experience. In one embodiment of the present invention, there are magnets built into the base of the case which are intended to magnetically attract a mounting plate which can be positioned on a tripod or four-legged stand. In another embodiment of the present invention, the connection between the mounting plate and the tripod or four-legged stand may be made with a standard threading such as a ¼″-20 threaded Screw or ⅜″-16 threaded Screw. In another embodiment of the present invention, the connection between the mounting plate and the tripod or four-legged stand may be made with a quick release system such as the Arca-Swiss Quick Release System.

In an alternative embodiment of the present invention the shade assembly consists of a top visor panel and upper and lower side panels on each side of the case wherein the shade assembly is detachable for interoperability. In yet another embodiment of the present invention, the shade assembly consists of a top visor panel, upper and lower side panels on each side of the case, and a rear panel wherein the shade assembly is detachable for interoperability.

In an alternative embodiment of the present invention side gussets are positioned to expand between the lid of the case and the base of the case on each side designed to block the sun from the side angles. The two side gussets may also help support the weight of the case lid of the clamshell case in its opened position.

In an alternative embodiment of the present invention, a cut-out area in each of the side gussets is configured for accommodating the passage of power cables; wherein said cut-out area is located proximate to the rear end of the base of the case, allowing convenient access for threading power cables through the side gussets while maintaining a laptop device enclosed within the clamshell case in it's opened position.

Another embodiment of the present invention includes a friction hinge connecting the lid and the base of the case which defines the angle of the opened case.

In an alternative embodiment, the laptop case and foldable shade system further comprises a built-in battery and charging port in the base of the case that provides an additional power source for a laptop.

There are no other solutions with a clamshell style case that also have a foldable shade assembly wherein the shade assembly can be folded flat and securely stored vertically within the lid of the case while the lower side panels maintain a connection to the lid of the case. Further, there are no other clamshell style case solutions where the foldable shade assembly consists of a top visor panel and two side panels on each side of the case which fold inward along a center hinge that connects the two side panels in order for the shade assembly to fold within the interior planar surface of the lid. This unique functionality allows the folded shade assembly to be stored in a novel fashion.

No other products teach a clamshell style laptop case wherein the lid half of the case and the base half of the case are connected via a rear hinge, which may include a friction hinge.

No other products teach a clamshell style laptop case wherein the top visor panel is attached to an upper edge of the case lid by way of a hinge.

No other products teach a clamshell style case wherein the shade assembly can be detached and replaced with another shade for interoperability.

No other products contain a recess along the bottom of the base of the case whereby the case can be mounted to a mounting plate with connection components for a tripod or four-legged stand to create a portable or mobile desk experience.

No other laptop case and shade systems further comprise a built-in battery or charging port in the base of the case that provides an additional power delivery source for a laptop contained within it.

No other laptop case and shade systems further include side gussets to maximize the amount of sun coverage.

### BRIEF DESCRIPTION OF THE DRAWINGS

FIG. 1 is a perspective view of an exemplary embodiment of the present invention, with the clamshell case shown in an open configuration with the shade assembly expanded;

FIG. 2 is a perspective view of an exemplary embodiment of the present invention, with the clamshell case in an open configuration with the shade assembly in its partially folded state;

FIG. 3 is a perspective view of an exemplary embodiment of the present invention, with the clamshell case shown in an open configuration with the shade assembly in its partially folded state;

FIG. 4 is a perspective view of an exemplary embodiment of the present invention, with the clamshell case shown in an open configuration with the shade assembly in its folded state;

FIG. 5 is a perspective view of an exemplary embodiment of the present invention, with the clamshell case shown in a closed configuration;

FIG. 6 is a perspective view of an alternative embodiment of the present invention, with the clamshell case shown in an open configuration wherein a laptop is removed and dashed lines are used to show the placement of embedded magnets in the base half of the case;

FIG. 7 is a perspective view of an alternative embodiment of the present invention with the clamshell case shown in an open configuration wherein the shade assembly is shown detached from the lid half of the case;

FIG. 8 is a perspective view of an alternative embodiment of the present invention with the clamshell case shown in an open configuration wherein the shade assembly is shown attached to the lid half of the case and wherein the shade assembly includes a rear panel;

FIG. 9 is a perspective view of an alternative embodiment of the present invention with the clamshell case shown in an open configuration wherein the shade assembly is shown detached to the lid half of the case and wherein the shade assembly includes a rear panel;

FIG. 10 is a perspective view of an alternative embodiment of the present invention with the clamshell case shown in an open configuration where side gussets on each side of the case are attached to the lid half of the case and the base of the case;

FIG. 11 is a perspective view of an alternative embodiment of the present invention showing the bottom of the base half of the case with an optional embedded battery 26 and charging port 24;

FIG. 12 is a perspective view of an alternative embodiment of the present invention showing the case with foldable shade;

FIG. 13 is an exploded view of an alternative embodiment of the present invention showing the case detached from the mounting plate for a tripod or four-legged stand and recess on the bottom base half of the case to accept the mounting plate; and

FIG. 14 is an exploded view of an alternative embodiment of the present invention showing the base half of the case, mounting plate, screw or other attachment component, and tripod or four-legged stand.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a laptop case and foldable shade system. The clamshell laptop case provides a lid of the case which is connected to a base of the case via a hinge which joins the lid of the case and base of the case along their adjacent rear edges so that the case moves between an open configuration and a closed configuration. The lid of the case and base of the case each have two side edge portions and a front edge portion (opposite the hinge that connects the lid of the case and base of the case). Said two side edge portions and front edge portions of both the lid of the case and the base of the case come into contact with one another when the case is moved from its opened position to its closed position. Said two side edge portions and front edge portions may also contain fasteners, such as but not limited to a zipper or magnets for securely joining the lid half of the case and the base half of the case when the case is in the closed configuration.

An embodiment of the present invention includes a shade assembly consisting of a top visor panel and two side panels on each side of the case. The top visor panel is attached to the top portion of the case lid to partially shield a laptop device placed within the case from direct sun exposure when it's extended position. The shade assembly can be moved into its storage position by lowering the top visor panel while the side panels fold inward along the interior planar surface of the case lid. When fully collapsed, the top visor panel and the side panels are positioned within the interior planar surface of the lid.

The present invention contains two side panels on each of the left and right sides of the case lid: an upper side panel and a lower side panel, wherein the upper side panel is attached to the top visor panel on either the left or right side, respectively, and the lower side panel is attached to the case lid on either the left or a right side, respectively.

The shade assembly of the present invention can be moved from its expanded position to its folded position by lowering the top visor panel while the upper side panels and lower side panels fold inward along the interior planar surface of the case lid. When fully folded, the top visor panel and side panels are flattened and positioned within the interior planar surface of the case lid. The upper side panel and the lower side panel on each side of the case are connected by a joining hinge, which may be a living hinge, friction hinge, piano hinge, or spring hinge. When moving the shade to its folded position, the upper and lower side panels fold inward along their joining hinge. In this embodiment, when stowing the shade assembly, the top visor panel folds downward from its extended position as the upper and lower side panels fold inward along the interior planar surface of the case lid in a flattened position, substantially parallel with the interior surface of the lid

In one embodiment two gussets interconnect the lid of the case to the base of the case along their respective two side edge portions so that as the laptop case is brought into a closed position from its open position, the side gussets fold inward within the laptop case.

In another embodiment of the present invention, a cut-out area in each of the side gussets is configured for accommodating the passage of power cables; wherein said cut-out area is located proximate to the rear end of the base of the case, allowing convenient access for threading power cables through the side gussets while maintaining a laptop device enclosed within the clamshell case in it's opened position.

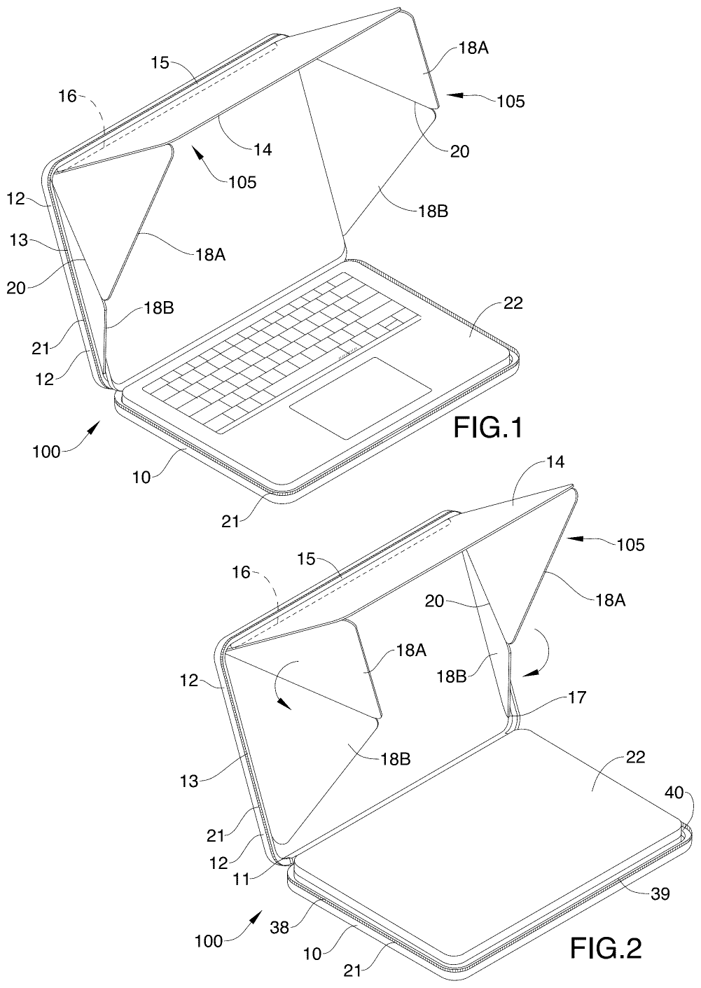

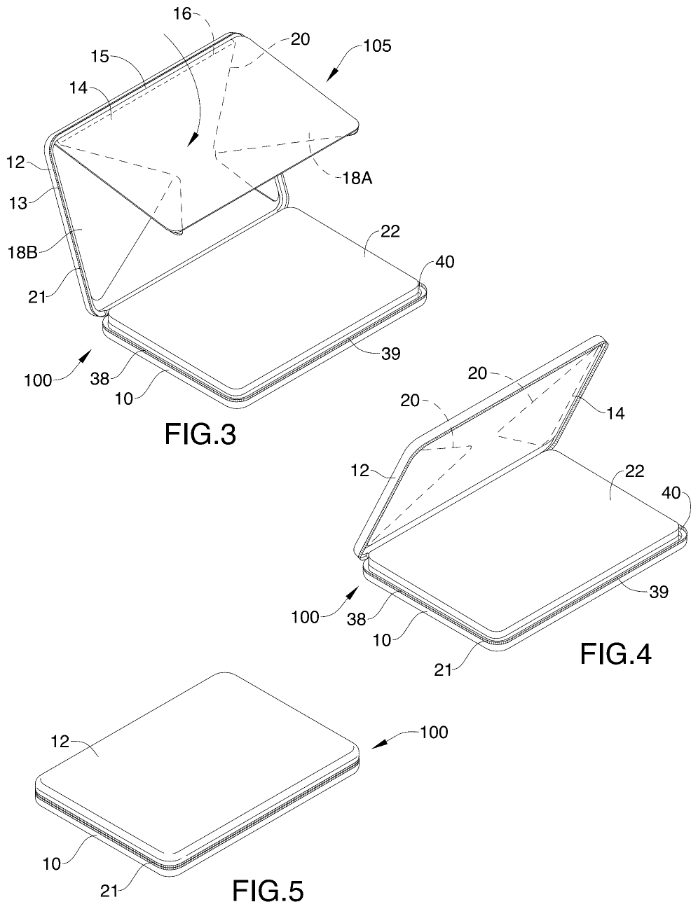

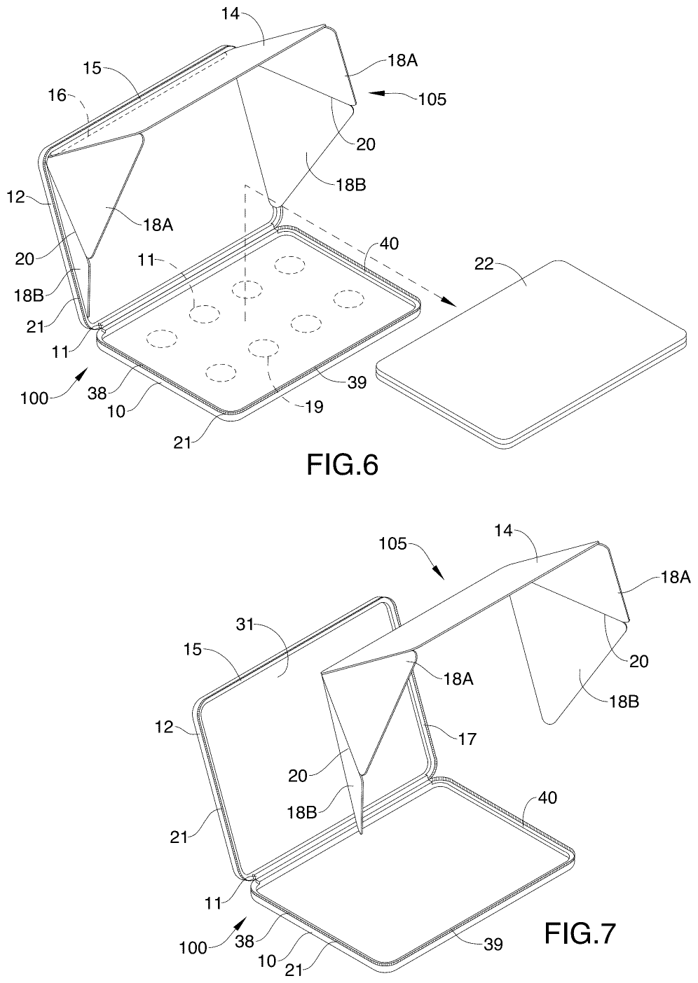

Referring now to FIGS. 1 through 14, the present invention may include a laptop case 100 for a laptop 22. The laptop case 100 may have a clamshell arrangement, wherein a lid 12 of the case is pivotably connected to a base 10 of the case via a rear hinge 11 along the length of both of their adjacent rear edges so that the lid 12 of the case and base 10 of the case can move between an open configuration and a closed configuration. The lid 12 of the case is designed and dimensioned to contain the monitor assembly of a laptop 22, while the base 10 of the case is designed and dimensioned to contain a keyboard assembly of the laptop 22.

Referring specifically to FIGS. 1-5, the lid 12 of the case has an upper front edge 15, left edge 13, and right edge 17. The lid's upper front edge 15, left edge 13, and right edge 17 perpendicularly extend from the lid 12 of the case and come into contact with the base 10 of the case at its corresponding front edge 39, left edge 38, and right edge 40 when the case is in the closed configuration as shown in FIG. 5. The case lid's upper front edge 15, left edge 13, and right edge 17 and the corresponding front edge 39, left edge 38, and right edge 40 of the base 10 may each have complimentary fastener, which may include, but not limited to a zipper 21, for securely joining the lid 12 half of the case and the base 10 half of the case when the case is in the closed configuration. Alternatively, magnets may be present on the edge portions of the case lid and the base of the case for securely joining the lid of the case and the base of the case when the case is in the closed position. The lid 12 of the case and the base 10 of the case may be made of EVA foam, TPU, or other materials suitable for a laptop case.

Referring to FIGS. 1-6 of the present invention contemplates a clamshell case 100 with lid 12 of the case and the base 10 of the case, wherein a shade assembly 105 is attached along an upper front edge 15 of the lid 12 of the case. The shade assembly 105 includes a top visor panel 14 attached to an upper front edge 15 of the lid 12 of the case by way of an upper hinge 16, and two side panels on each side of the case: an upper side panel 18a and a lower side panel 18b. When the shade assembly 105 is in its expanded position, the top visor panel 14 is extended outward to partially shield a laptop device placed within the case from direct sun exposure. In an alternative embodiment, a top visor panel 14 is attached to an upper front edge 15 of the case lid 12 by way of a hinge.

FIGS. 1-2 of the present invention show two side panels on each of the left and right sides of the case lid: an upper side panel 18a and a lower side panel 18b, wherein the upper side panel 18a is attached to the top visor panel 14 on either the left or right side, respectively, and the lower side panel 18b is attached to the case lid 12 on either the left edge 13 a right edge 17, respectively.

FIGS. 1-4 of the present invention show the shade assembly 105 being moved from its expanded position to its folded position by lowering the top visor panel 14 while the upper side panels 18a and lower side panels 18b fold inward along the interior planar surface of the case lid. When fully folded, the top visor panel 14 and side panels 18b and 18b are flattened and positioned within the interior planar surface of the lid 12 of the case. The upper side panel 18a and the lower side panel 18b on each side of the case are connected with a joining hinge 20, which may be a living hinge, friction hinge, piano hinge, or spring hinge. When moving the shade to its folded position, the upper and lower side panels 18a and 18b fold inward along their joining hinge 20. In this embodiment, when stowing the shade assembly 105, the top visor panel 14 folds downward from its extended position as the upper and lower side panels 18a and 18b fold inward along the interior planar surface of the lid half of the case in a flattened position, substantially parallel with the interior surface of the lid.

FIG. 7 shows an alternative embodiment in which the shade assembly 105 can be selectively attached and detached from the interior surface 31 of the case lid 12. In this embodiment the rear edges of the shade assembly 105 connect to the interior surface 31 of the case lid 12 magnetically or via another secure attachment method.

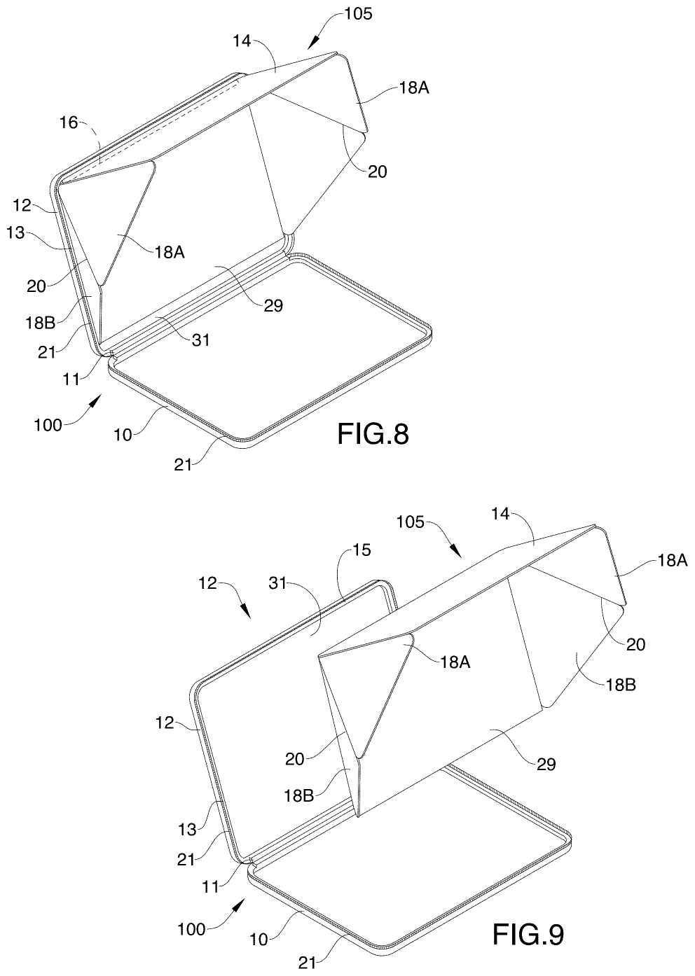

FIG. 8 shows an alternative embodiment with the clamshell case shown in an open configuration, wherein the shade assembly is shown attached to the lid half of the case and wherein the shade assembly includes a rear panel.

FIG. 9 shows an alternative embodiment in which the shade assembly 105 includes the rear panel 29 and in which the shade assembly 105 can be selectively attached and detached from the interior surface 31 of the case lid 12.

In one embodiment the back side of the rear panel 29 contains ferromagnetic material which magnetically connects to the magnetizable material in order to provide the secure attachment to the interior surface 31 of the lid of the case.

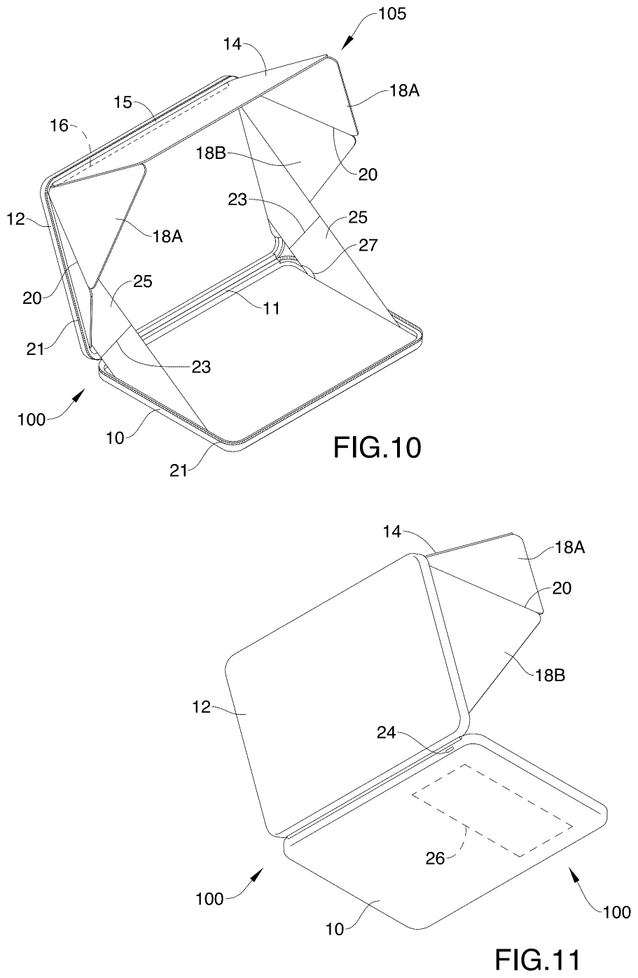

FIG. 10 shows an embodiment containing side gussets 25 where a left side gusset 25 may extend between a left edge 13 of the case lid 12 to the left edge of the base 10 of the case. Likewise, a right side gusset 25 may extend between the right edge 17 of the case lid 12 and the base 10 of the case. Each side gusset 25 may have a fold line 23 at approximately its midpoint to facilitate it folding inward when the laptop case 100 is shifted to the closed configuration. Each of the side gussets may contain a cut-out area 27 configured for accommodating the passage of power cables; wherein said cut-out area 27 is located proximate to the rear end of the base of the case, allowing convenient access for threading power cables through the side gussets 25 while maintaining a laptop device enclosed within the clamshell case in it's opened position.

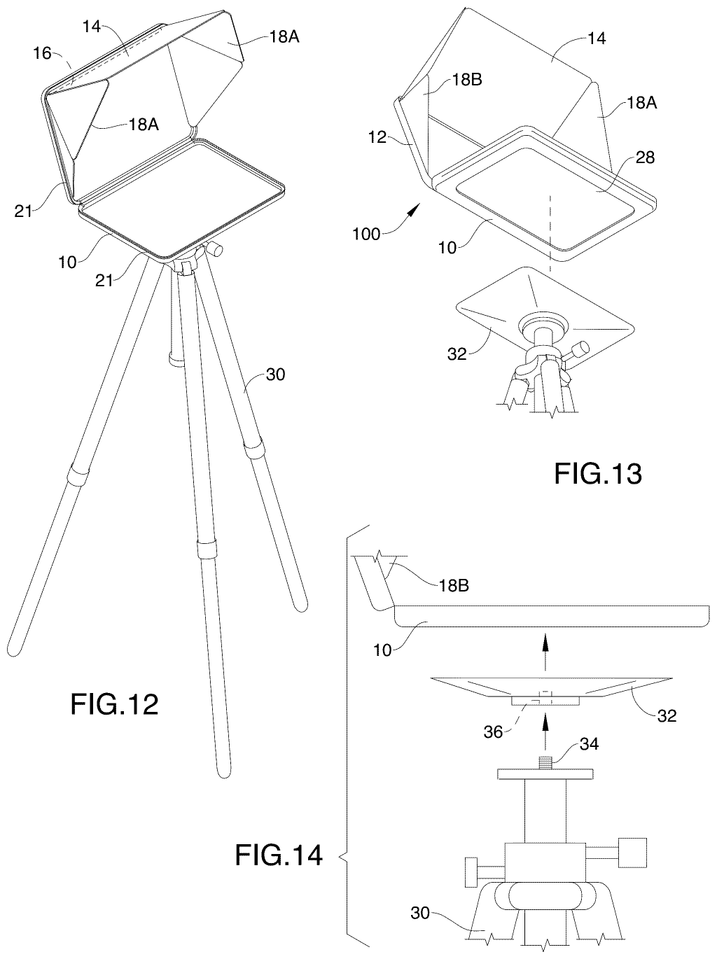

Referring to FIGS. 12-14, a bottom surface of the base 10 half of the case may provide a recess 28. Just inward of the recess 71 may be embedded magnets 19. The recess 28 may be dimensioned and adapted to receive an upper portion of a mounting plate 32. The upper portion of the mounting plate 32 may be made of ferromagnetic material that is magnetically attracted to embedded magnets 19. A lower portion of the mounting plate 32 may provide a connection component 36. The connection component 36 may be dimensioned and adapted to secure to a threaded shaft 34 along an upper portion of a tripod or four-legged stand 30. In an alternative embodiment, the connection component can be an alternative component such as a quick release system, for example the Arca-Swiss Quick Release System to establish the connection between the mounting plate 32 and the base 10 half of the case.

The present invention contemplates a recess 28 along the bottom of the base 10 half of the case whereby the base half of the case can connect to a mounting plate 32 with connection mechanisms to mount to a tripod or four-legged stand in order to create a portable or mobile desk experience. In one embodiment of the present invention, there are embedded magnets 19 in the base 10 half of the case which are intended to magnetically attract a mounting plate positioned on a tripod or four-legged stand. In one embodiment of the present invention the connection between the mounting plate 32 and the tripod or four-legged stand may be made with a standard threading such as a ¼″-20 threaded screw or ⅜″-16 threaded screw. In another embodiment of the present invention the connection between the mounting plate 32 and the tripod or four-legged stand may be made with a quick release system, such as the Arca-Swiss Quick Release System.

In an alternative embodiment, the laptop case and shade system further comprises a built-in battery 26 and charging port 24 in the base 10 half of the case that provides an additional power source.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affects the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

1. A laptop case and foldable shade assembly for a laptop having a keyboard hinged to a monitor, comprising:
a clamshell case having two halves:
a case lid; and
a base;
and
a shade component, having:
a top visor panel having a front side, a left side, a right side, and a rear side, wherein the rear side is attached directly to an upper edge of the case lid by a hinge;
a left upper side panel attached to the left side of the top visor panel;
a right upper side panel attached to the right side of the top visor panel;
a left lower side panel attached directly to the case lid; and
a right lower side panel attached directly to the case lid,
wherein the shade component is configured such that the top visor panel, left lower side panel, and right lower side panel are configured to remain attached directly to the case lid regardless of a relative orientation between the case lid and the base,
wherein the shade component is configured to remain open without contacting the base, and
wherein the case lid and the base are joined together along their adjacent rear edges with a friction hinge configured to allow the lid to open beyond a generally normal orientation relative to the base while the shade assembly is fully expanded.

2. The laptop case and foldable shade assembly of claim 1, wherein the shade assembly in its storage position consists of the upper and lower side panels and the top visor panel which are folded inward along the interior planar with the interior surface of the lid.

3. The laptop case and foldable shade assembly of claim 2, wherein when stowing the shade assembly, the upper and lower side panels fold inward along an interior planar surface of the case lid in a flattened position, substantially parallel with an interior surface of the lid of the case.

4. The laptop case and foldable shade assembly of claim 1, wherein the upper side panel and the lower side panel on each side of the case lid are connected by a joining hinge.

5. The laptop case and foldable shade assembly of claim 1, wherein the respective upper and lower side panels are attached by at least of: a spring hinge; a friction hinge; a living hinge; and a piano hinge.

6. (canceled)

7. (canceled)

8. The laptop case and foldable shade assembly of claim 1, further comprising two side gussets, each side gusset connecting the lid of the case to the base of the case along their respective two side edge portions so that as the clamshell case is brought to a closed condition from an open condition the two side gussets fold inward within the clamshell case.

9. The laptop case and foldable shade assembly of claim 1, further comprising:
i. a recess along a bottom surface of the base of the case;
ii. magnets embedded in the base positioned above the recess; and
iii. a mounting plate dimensioned to be received in the recess.

10. The laptop case and foldable shade assembly of claim 1, further comprising a built-in battery and a charging port in the base of the case that provide a power source.

11. The laptop case and foldable shade assembly of claim 1, further comprising a cut-out area in each of the side gussets, where said cut-out area is configured for accommodating the passage of power cables

12. The laptop case and foldable shade assembly of claim 1, further comprising zipper teeth positioned around the perimeter of the case lid and of the base of the case for securely joining the lid of the case and the base of the case when the case is in a closed configuration.

13. The laptop case and foldable shade assembly of claim 1, further comprising magnets positioned around the edge portions of the lid of the case and of the base of the case for securely joining the lid to the base when the case is in the closed configuration.

14. The laptop case and foldable shade assembly of claim 1, further comprising a detachable shade assembly consisting of a top visor panel and upper and lower side panels on each side of the case.

15. The laptop case and foldable shade assembly of claim 1, further comprising a detachable shade assembly consisting of a top visor panel, upper and lower side panels on each side of the case, and a rear panel.

16. A method of traversing the laptop and the laptop case and foldable shade assembly of claim 1, the method comprising:
unlocking at least one side of the lid of the clamshell case from the base of the lap clamshell top case;
traversing the lid to a first angle defined by the lid and the base;
maintaining the first angle of the lid and the base with the friction hinge that connects the lid and the base;
traversing the shade component from a folded position to an extended position to provide shade to the laptop monitor and shield the laptop monitor from sunlight while the lower side panels of the shade component remain attached to the lid;
traversing the laptop monitor to a second angle defined by the laptop keyboard and the laptop monitor, wherein the second angle is matched to the first angle.

17. A method of traversing the laptop and the laptop case and foldable shade assembly of claim 1, the method comprising:
unlocking the lid of the clamshell case from the base of the clamshell case;
traversing the lid to a first angle defined by the lid and the base;
maintaining the first angle of the lid and the base with the friction hinge that connects the lid and the base;
traversing the shade component from a folded position to an extended position to provide shade to the laptop monitor and shield the laptop monitor from sunlight;
traversing the laptop monitor to a second angle defined by the laptop keyboard and the laptop monitor.

18. A method of traversing the laptop case and foldable shade assembly of claim 1 from an opened position to a closed position, the method comprising:
traversing the laptop monitor toward the laptop keyboard;
traversing the shade component from an extended position, wherein the shade component provides shade to the laptop monitor and shields the laptop monitor from sunlight, to a folded position while the lower panels of the shade component remain attached to the lid;
traversing the lid toward the base;
locking the lid of the laptop case to the base of the laptop case to secure the laptop between the lid and the base.

19. The laptop case and foldable shade assembly of claim 1, wherein the shade assembly is configured such that, in an open position, the left upper side panel and left lower side panel are noncoplanar, and the right upper side panel and right lower side panel are noncoplanar.
